(19) United States
(12) Patent Application Publication
(10) Pub. No.: US 2011/0166929 A1
(43) Pub. Date: Jul. 7, 2011

(54) SYSTEM AND METHOD FOR PROVIDING SEARCH RESULTS BASED ON SIMILARITY AMONG CONTENTS AND SYSTEM AND METHOD FOR PROVIDING ADVERTISEMENTS

(75) Inventors: Youn Sik Lee, Seongnam-si (KR); Dong Wook Kim, Seongnam-si (KR); Yuwon Kim, Seongnam-si (KR); Jung Soo Ha, Seongnam-si (KR)

(73) Assignee: NHN BUSINESS PLATFORM CORPORATION, Seongsam-si (KR)

(21) Appl. No.: 12/990,449

(22) PCT Filed: Feb. 26, 2009
(86) PCT No.: PCT/KR09/00908

§ 371 Date: Jan. 24, 2011

(30) Foreign Application Priority Data
Apr. 29, 2008 (KR) 10-2008-0040012

(51) Int. Cl. G06Q 30/00; G06F 17/30

(52) U.S. Cl. 705/14.49; 707/770

(57) ABSTRACT

Provided are a system and method for providing a search result based on a similarity between contents and a system and method for providing an advertisement. The search result providing system may include: a content retrieval unit to retrieve a content corresponding to a user query; a similar content verification unit to verify a similar content based on at least one portion of the retrieved content; and a content provider to provide the retrieved content and the similar content in response to the user query.

### TECHNICAL FIELD

Exemplary embodiments of the present invention relate to a system and method for providing a search result based on a similarity between contents and a system and method for providing an advertisement, and more particularly, to a method and system for additionally providing a content such as an advertisement and the like based on a content instead of using a keyword.

### BACKGROUND ART

A keyword advertisement corresponds to a type of an advertisement of exclusively exposing a corresponding advertisement on a search result page when advertisers purchase a particular keyword and then users perform a search using the keyword. Since the keyword advertisement can display an advertisement content to only a user having an interest in a particular product or matter, it is possible to enhance the effect of a targeted advertisement, and to increase a click rate on the advertisement.

In the above keyword advertisement field, advertisers may desire to maximize the advertising effect by enabling their advertisements to be more frequently exposed for users. In addition, media may desire to increase sales by expanding an advertisement range. Accordingly, proposed is a system and method for providing a search result that may effectively increase the advertising effect and sales.

### DISCLOSURE OF INVENTION

### Technical Goals

Exemplary embodiments of the present invention provide a system and method for providing a search result that may additionally provide not only a content retrieved in response to a user query input from a user, but also a similar content verified through a content similarity with the retrieved content and thereby may more effectively provide the user with search results corresponding to the user query.

Exemplary embodiments of the present invention also provide a system and method for providing an advertisement that may provide not only an advertisement retrieved in response to a user query input from a user, but also a similar advertisement verified through a content similarity with the retrieved advertisement and thereby may more effectively provide the user with an additional advertisement and enhance the advertising effect and sales.

Exemplary embodiments of the present invention also provide a system and method for providing an advertisement that may provide an additional advertisement through a remaining content excluding a corresponding advertisement from a content retrieved in response to a user query input from a user, and thereby may effectively provide the user with the additional advertisement and enhance the advertising effect and sales.

### Technical Solutions

An exemplary embodiment of the present invention discloses a system for providing a search result, including: a content retrieval unit to retrieve a content corresponding to a user query; a similar content verification unit to verify a similar content based on at least one portion of the retrieved content; and a content provider to provide the retrieved content and the similar content in response to the user query.

The similar content verifying unit may verify the similar content using a similarity between contents based on a vocabulary corresponding to at least one portion of the retrieved content.

The similar content verification unit may include: a representative keyword verification unit to verify a representative keyword with respect to at least one portion of the retrieved content; and a similar content determination unit to determine, as the similar content, a content having the same representative keyword as the verified representative keyword. The representative keyword may be determined based on a click log.

The user query may be received using a user terminal, and the content provider may transmit, to the user terminal, uniform resource locator (URL) information of a page including the retrieved content and the similar content or URL information of each of a page including the retrieved content and a page including the similar content.

An exemplary embodiment of the present invention discloses a system for providing an advertisement, including: an advertisement retrieval unit to retrieve an advertisement of an advertiser purchasing a keyword corresponding to a user query; a similar advertisement verification unit to verify a similar advertisement based on at least one portion of the advertisement of the advertiser; and an advertisement provider to provide the advertisement of the advertiser and the similar advertisement in response to the user query.

An exemplary embodiment of the present invention discloses a system for providing an advertisement, including: a content retrieval unit to retrieve a content corresponding to a user query; an additional advertisement verification unit to verify an additional advertisement based on at least one portion of a remaining content excluding the advertisement from the retrieved content; and an advertisement provider to provide the content and the additional advertisement.

An exemplary embodiment of the present invention discloses a method of providing a search result, including: retrieving a content corresponding to a user query; verifying a similar content based on at least one portion of the retrieved content; and providing the retrieved content and the similar content in response to the user query.

An exemplary embodiment of the present invention discloses a method of providing an advertisement, including: retrieving an advertisement of an advertiser purchasing a keyword corresponding to a user query; verifying a similar advertisement based on at least one portion of the advertisement of the advertiser; and providing the advertisement of the advertiser and the similar advertisement in response to the user query.

An exemplary embodiment of the present invention discloses a method of providing an advertisement, including: retrieving a content corresponding to a user query; verifying an additional advertisement based on at least one portion of a remaining content excluding the advertisement from the retrieved content; and providing the content and the additional advertisement.

### Advantageous Effect

According to exemplary embodiments of the present invention, it is possible to more effectively provide a user with search results corresponding to a user query by additionally providing not only a content retrieved in response to the user query input from the user, but also a similar content verified through a content similarity with the retrieved content.

According to exemplary embodiments of the present invention, it is possible to more effectively provide a user with an additional advertisement, and to enhance the advertising effect and sales by providing not only an advertisement retrieved in response to a user query input from the user, but also a similar advertisement verified through a content similarity with the retrieved advertisement.

According to exemplary embodiments of the present invention, it is possible to effectively provide a user with an additional advertisement, and to enhance the advertising effect and sales by providing the additional advertisement through a remaining content excluding a corresponding advertisement from a content retrieved in response to a user query input from the user.

### BRIEF DESCRIPTION OF DRAWINGS

FIG. 1 is a block diagram to describe a configuration of a system for providing a search result according to an exemplary embodiment of the present invention.

FIG. 2 is a flowchart illustrating a method of providing a search result according to an exemplary embodiment of the present invention.

FIG. 3 is a block diagram illustrating a configuration of a system for providing a search result according to an exemplary embodiment of the present invention.

FIG. 4 is a flowchart illustrating a method of providing an advertisement according to an exemplary embodiment of the present invention.

FIG. 5 is a diagram illustrating an example of providing an advertisement according to an exemplary embodiment of the present invention.

FIG. 6 is a block diagram illustrating a configuration of an advertisement providing system according to an exemplary embodiment of the present invention.

FIG. 7 is a flowchart illustrating a method of providing an advertisement according to another exemplary embodiment of the present invention.

FIG. 8 is a diagram illustrating an example of providing an advertisement according to another exemplary embodiment of the present invention.

FIG. 9 is a block diagram illustrating a configuration of an advertisement providing system according to another exemplary embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

Hereinafter, various exemplary embodiments of the present invention will be described with reference to the accompanying drawings.

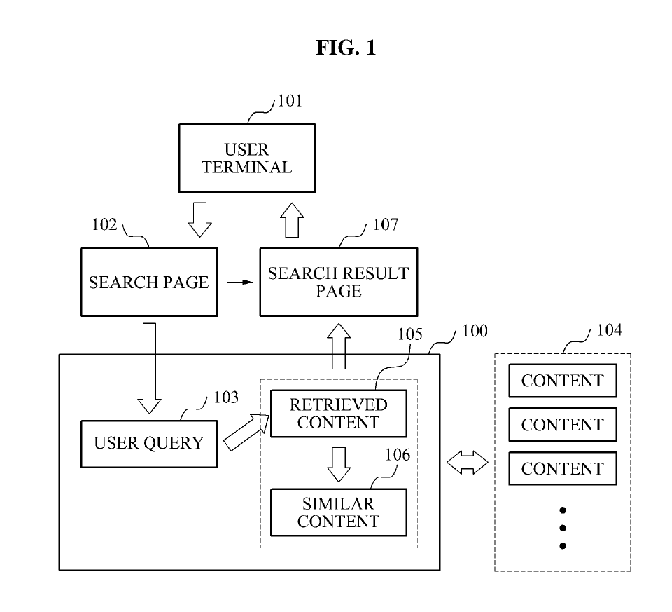

FIG. 1 is a block diagram to describe a configuration of a system 100 for providing a search result according to an exemplary embodiment of the present invention. The search result providing system 100 may receive a user query 103 that is input through a search page 102 by a user using a user terminal 101, and may search a plurality of contents 104 for a content corresponding to the user query 103. The search result providing system 100 may generate a search result including a content 105 retrieved in response to the user query 103 and a similar content 106, and may expose a search result page 107 using the user terminal 101 or expose uniform resource locator (URL) information of each of a page including the retrieved content 105 and a page including the similar content 106 through the search result page 107. Through this, the search result providing system 100 enables the user to be provided with more search results using the user query 103. The similar content 106 may be verified based on a similarity between the retrieved content 105 and each of the contents 104. In the present specification, the term ‘similarity’ may indicate a similar degree between contents such as a text, an advertisement, and the like. All the methods, for example, a correlation between words, a title and description (T&D) correlation, and the like may be employed to indicate the similar degree between the contents. However, for concise description, the similarity between contents may be verified by verifying only a similarity through matching of representative keywords of contents. Specifically, even though not described here, it is possible to measure various classes of similarities and additionally provide only a content having a similarity of at least reference class.

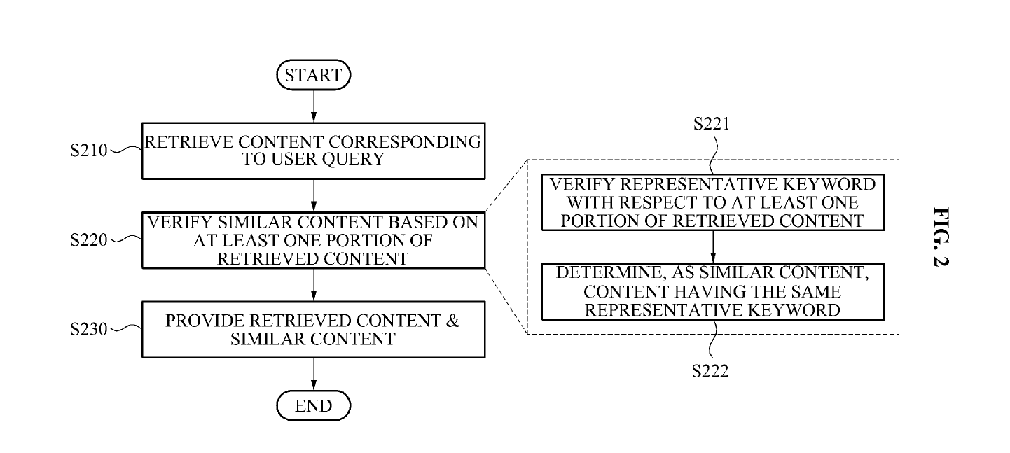

FIG. 2 is a flowchart illustrating a method of providing a search result according to an exemplary embodiment of the present invention. The search result providing method may be performed by a search result providing system according to an exemplary embodiment of the present invention. In FIG. 2, the search result providing method will be described by describing each operation performed by the search result providing system.

In operation S210, the search result providing system may retrieve a content corresponding to a user query. The search result providing system may retrieve the content corresponding to the user query by employing a search engine and the like with respect to the user query input from a user.

In operation S220, the search result providing system may verify a similar content based on at least one portion of the retrieved content. Specifically, the retrieved content may include a single content or at least one content. The search result providing system may verify the similar content using at least one portion of the single content or at least one content. For example, when three contents are retrieved in response to the user query, the search result providing system may verify the similar content with respect to each of two contents among three contents. Also, the search result providing system may verify the similar content with respect to a single content among three contents or may verify the similar content through a portion of the single content.

For the above operation, the search result providing system may verify the similar content using a similarity between contents based on a vocabulary corresponding to at least one portion of the retrieved content. For example, as shown in FIG. 2, the search result providing system may perform operations S221 and S222 included in operation S220.

In operation S221, the search result providing system may verify a representative keyword with respect to at least one portion of the retrieved content. For example, the search result providing system may verify the representative keyword with respect to at least one portion of the retrieved content or each of at least one content. For example, the representative keyword may be determined based on a click log. That is, the representative keyword may be determined with respect to each of contents using the click log with respect to each user query. Even though the representative keyword with respect to contents is determined using the click log herein, it is only an example. Accordingly, the present invention is not limited thereto and it will be apparent to those skilled in the art that various modifications and changes may be made. For example, instead of using the click log, a keyword most frequently included in each of contents or a portion of the contents may be determined as the representative keyword, or a keyword having a highest correlation between the user query and a word among keywords of contents may be determined as the representative keyword.

In operation S222, the search result providing system may determine, as the similar content, a content having the same representative keyword as the verified representative keyword. As described above, the representative keyword may be determined with respect to each of the contents. The search result providing system may determine, as the similar content, another content having, as the representative keyword, the same keyword as the representative keyword determined with respect to the retrieved content. For example, when a representative keyword of a single content among retrieved contents is ‘bulb’, all the contents having ‘bulb’ as the representative keyword among the entire contents may be determined as similar contents. Here, a number of similar contents may be adjusted based on a preset value or a predetermined value.

In operation S230, the search result providing system may provide the retrieved content and the similar content in response to the user query. The user query may be received using a user terminal of the user. The search result providing system may provide the retrieved content and the similar content by transmitting, to the user terminal, URL information of a page including the retrieved content and the similar content or URL information of each of a page including the retrieved content and a page including the similar content.

Accordingly, even though only the retrieved content is provided in response to the user query in the related art, the search result providing method according to the exemplary embodiment of the present invention may provide the user with various search results by providing not only the retrieved content but also the similar content having a similarity with the retrieved content.

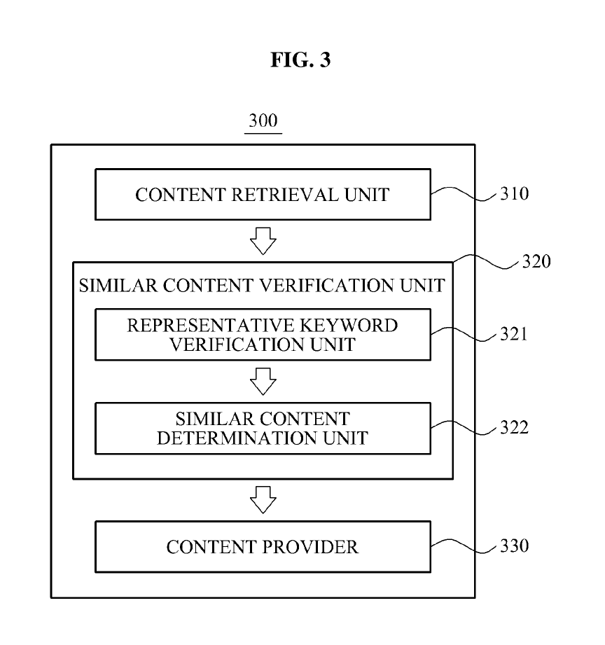

FIG. 3 is a block diagram illustrating a configuration of a system 300 for providing a search result according to an exemplary embodiment of the present invention. As shown in FIG. 3, the search result providing system 300 may include a content retrieval unit 310, a similar content verification unit 320, and a search result provider 330.

The content retrieval unit 310 may retrieve a content corresponding to a user query. The content retrieval unit 310 may retrieve the content corresponding to the user query by employing a search engine and the like with respect to the user query input from the user.

The similar content verification unit 320 may verify a similar content based on at least one portion of the retrieved content. Specifically, the retrieved content may include a single content or at least one content. The similar content verification unit 320 may verify the similar content using at least one portion of the single content or the at least one content. For example, when three contents are retrieved in response to the user query, the similar content verification unit 320 may verify the similar content with respect to each of two contents among three contents. Also, the similar content verification unit 320 may verify the similar content with respect to a single content among three contents or may verify the similar content through a portion of the single content.

For the above operation, the similar content verification unit 320 may verify the similar content using a similarity between contents based on a vocabulary corresponding to at least one portion of the retrieved content. For example, as shown in FIG. 3, the similar convent verification unit 320 may include a representative keyword verification unit 321 and a similar content determination unit 322.

The representative keyword verification unit 321 may verify a representative keyword with respect to at least one portion of the retrieved content. For example, the representative keyword verification unit 321 may verify the representative keyword with respect to at least one portion of the retrieved content or each of at least one content. For example, the representative keyword may be determined based on a click log. That is, the representative keyword may be determined with respect to each of contents using the click log with respect to each user query. Even though the representative keyword verification unit 320 of determining the representative keyword of the content using the click log is described herein, it is only an example. Accordingly, the present invention is not limited thereto and it will be apparent to those skilled in the art that various modifications and changes may be made. For example, instead of using the click log, the representative keyword verification unit 320 may determine, as the representative keyword, a keyword most frequently included in each of contents or a portion of the contents or a keyword having a highest correlation between the user query and a word among keywords of contents.

The similar content determination unit 322 may determine, as the similar content, a content having the same representative keyword as the verified representative keyword. As described above, the representative keyword may be determined with respect to each of the contents. The similar content determination unit 322 may determine, as the similar content, another content having, as the representative keyword, the same keyword as the representative keyword determined with respect to the retrieved content. Here, a number of similar contents may be adjusted based on a preset value or a predetermined value.

The content provider 330 may provide the retrieved content and the similar content in response to the user query. The user query may be received using a user terminal of the user. The content provider 330 may provide the retrieved content and the similar content by transmitting, to the user terminal, URL information of a page including the retrieved content and the similar content or URL information of each of a page including the retrieved content and a page including the similar content.

As described above, a search result providing system or a search result providing method according to an exemplary embodiment of the present invention may more effectively provide a user with more search results corresponding to a user query by providing not only a content retrieved in response to the user query input from the user but also a similar content verified through a content similarity with the retrieved content.

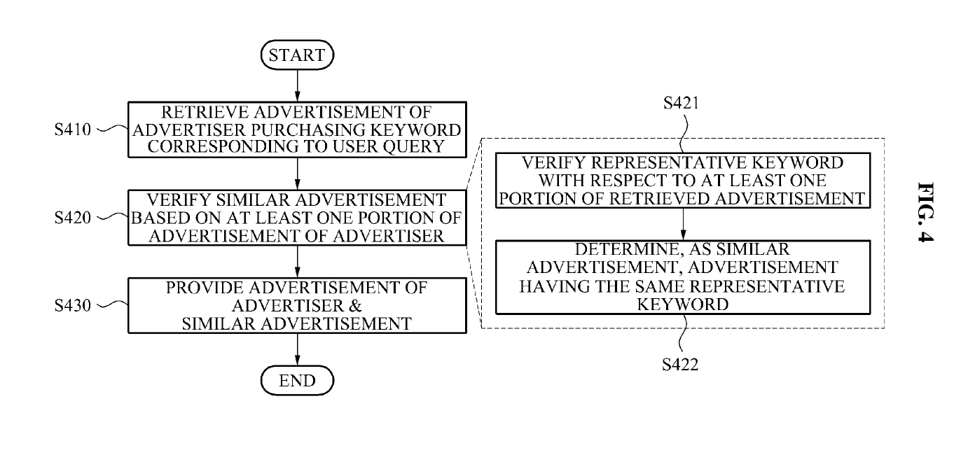

FIG. 4 is a flowchart illustrating a method of providing an advertisement according to an exemplary embodiment of the present invention. The advertisement providing method may be performed by an advertisement providing system according to an exemplary embodiment of the present invention. In FIG. 4, the advertisement providing method will be described by describing each operation performed by the advertisement providing system.

In operation S410, the advertisement providing system may retrieve an advertisement of an advertiser purchasing a keyword corresponding to a user query. For example, when a ‘basketball’ is input as the user query, the advertisement providing system may retrieve an advertisement of an advertiser purchasing the user query ‘basketball’ as a keyword.

In operation S420, the advertisement providing system may verify a similar advertisement based on at least one portion of the advertisement of the advertiser. The advertisement providing system may verify the similar advertisement using a similarity between contents based on a vocabulary included in at least one portion of the advertisement of the advertiser. For example, as shown in FIG. 4, the advertisement providing system may perform operations S421 and S422 included in operation S420.

In operation S421, the advertisement providing system may verify a representative keyword with respect to at least one portion of the advertisement of the advertiser. The representative keyword may be determined based on a click log. For example, a keyword causing most frequent clicks on an advertisement exposed in response to the user query may be determined as the representative keyword based on a click log with respect to an URL of the exposed advertisement. Instead of using the click log, the representative keyword may be verified based on T&D input from the advertiser with respect to the advertisement content or the advertisement. For example, a vocabulary included in the advertisement content, a vocabulary most frequently used in the T&D, or a vocabulary having a highest correlation between the user query and a word may be verified as the representative keyword.

In operation S422, the advertisement providing system may determine, as the similar advertisement, an advertisement having the same representative keyword as the verified representative keyword. With respect to each of advertisements, the representative keyword may be determined. The advertisement providing system may determine, as the similar advertisement, another advertisement having, as the representative keyword, the same keyword as the representative keyword determined with respect to the advertisement of the advertiser. Here, a number of similar advertisements may be adjusted based on a preset value or a predetermined value.

In operation S430, the advertisement providing system may provide the advertisement of the advertiser and the similar advertisement in response to the user query. The advertisement providing system may provide the advertisement of the advertiser and the similar advertisement by transmitting, to a user terminal of the user, URL information of a page including the advertisement of the advertiser and the similar advertisement or URL information of each of a page including the advertisement of the advertiser and a page including the similar advertisement.

Specifically, the advertisement providing system may expose not only the advertisement of the advertiser retrieved in response to the user query but also the similar advertisement associated with the advertisement of the advertiser. Accordingly, from view of the advertiser, it is possible to increase the advertising effect and sales. In addition, from view of media providing the advertisement, it is possible to increase sales according to advertisement exposure.

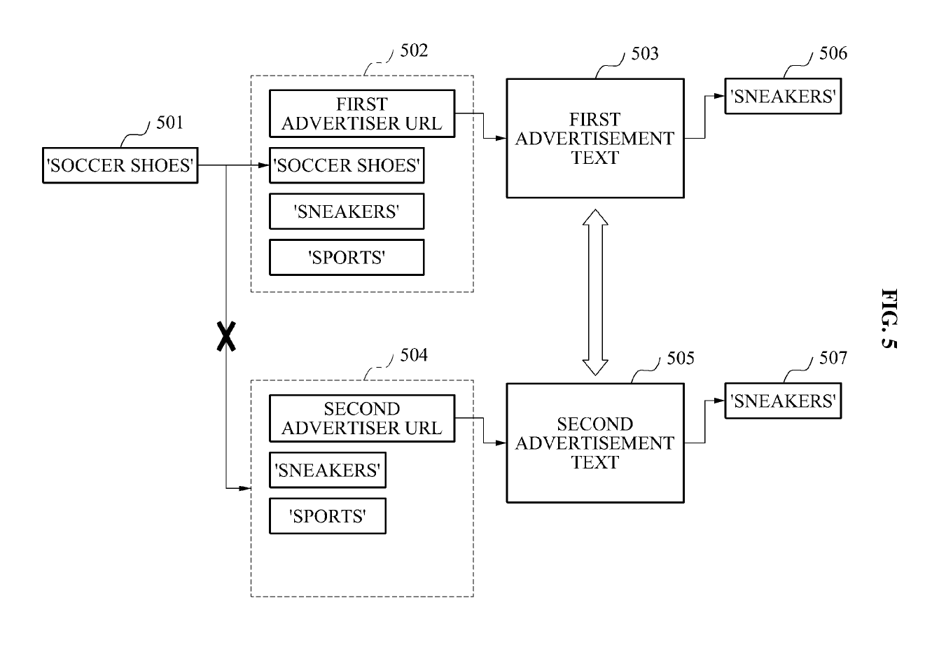

FIG. 5 is a diagram illustrating an example of providing an advertisement according to an exemplary embodiment of the present invention. When a user query ‘soccer shoes’ 501 is input from a user, an advertisement providing system according to an exemplary embodiment of the present invention may obtain information of a first advertiser 502 purchasing a keyword ‘soccer shoes’ through the user query ‘soccer shoes’ 501, and may expose URL information to the user, enabling the user to readily access a first advertisement text 503. As a similar advertisement, the advertisement providing system may provide the user with URL information associated with a second advertisement text 505 through information of a second advertiser 504 not purchasing the keyword ‘soccer shoes’.

For the above operation, the advertisement providing system may determine a is representative keyword ‘sneakers’ 506 with respect to the advertisement of the advertiser based on the URL information and a click log, or based on a vocabulary include in T&D information or the first advertisement text 503. The advertisement providing system may verify, as the similar advertisement, an advertisement having the same representative keyword as the representative keyword ‘sneakers’ 506 among other advertisements, and may provide both the first advertisement text 503 and the second advertisement text 505 having a similarity with the first advertisement text 503. Accordingly, it is possible to enhance the advertising effect and sales.

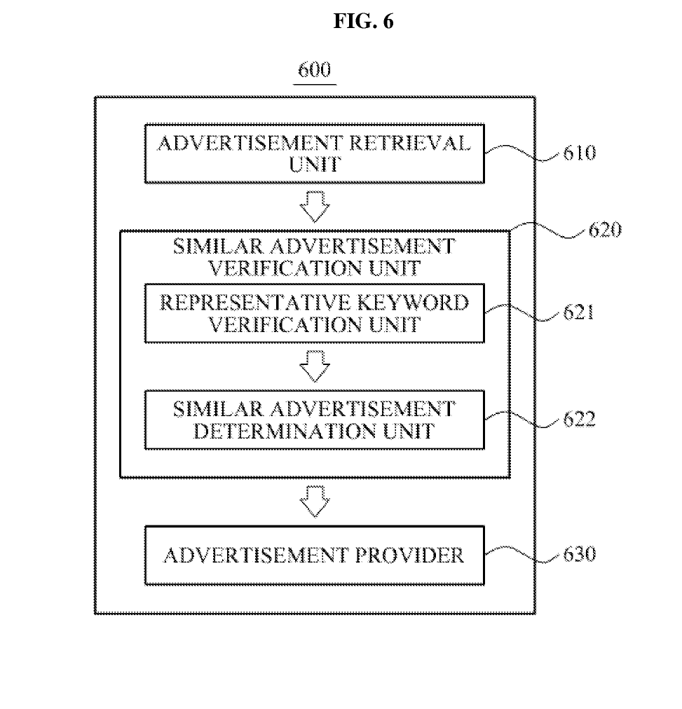

FIG. 6 is a block diagram illustrating a configuration of an advertisement providing system 600 according to an exemplary embodiment of the present invention. The advertisement providing system 600 may include an advertisement retrieval unit 610, a similar advertisement verification unit 620, and an advertisement provider 630.

The advertisement retrieval unit 610 may retrieve an advertisement of an advertiser purchasing a keyword corresponding to a user query. For example, when a ‘basketball’ is input as the user query, the advertisement retrieval unit 610 may retrieve an advertisement of an advertiser purchasing the user query ‘basketball’ as a keyword.

The similar advertisement verification unit 620 may verify a similar advertisement based on at least one portion of the advertisement of the advertiser. The similar advertisement verification unit 620 may verify the similar advertisement using a similarity between contents based on a vocabulary included in at least one portion of the advertisement of the advertiser. For example, as shown in FIG. 6, the similar advertisement verification unit 620 may include a representative keyword verification unit 621 and a similar advertisement determination unit 622.

The representative keyword verification unit 621 may verify a representative keyword with respect to at least one portion of the advertisement of the advertiser. The representative keyword may be determined based on a click log. For example, a keyword causing most frequent clicks on an advertisement exposed in response to the user query may be determined as the representative keyword based on a click log with respect to an URL of the exposed advertisement. Instead of using the click log, the representative keyword may be verified based on T&D input from the advertiser with respect to the advertisement content or the advertisement. For example, a vocabulary included in the advertisement content, a vocabulary most frequently used in the T&D, or a vocabulary having a highest correlation between the user query and a word may be verified as the representative keyword.

The similar advertisement determination unit 622 may determine, as the similar advertisement, an advertisement having the same representative keyword as the verified representative keyword. With respect to each of advertisements, the representative keyword may be determined. The similar advertisement determination unit 622 may determine, as the similar advertisement, another advertisement having, as the representative keyword, the same keyword as the representative keyword determined with respect to the advertisement of the advertiser. Here, a number of similar advertisements may be adjusted based on a preset value or a predetermined value.

The advertisement provider 630 may provide the advertisement of the advertiser and the similar advertisement in response to the user query. The advertisement provider 630 may provide the advertisement of the advertiser and the similar advertisement by transmitting, to a user terminal of the user, URL information of a page including the advertisement of the advertiser and the similar advertisement or URL information of each of a page including the advertisement of the advertiser and a page including the similar advertisement.

As described above, an advertisement providing system or an advertisement providing method according to an exemplary embodiment of the present invention may effectively provide a user with an additional advertisement and enhance the advertising effect and sales by providing both an advertisement retrieved in response to a user query input from the user and a similar advertisement verified using a similarity with the retrieved advertisement.

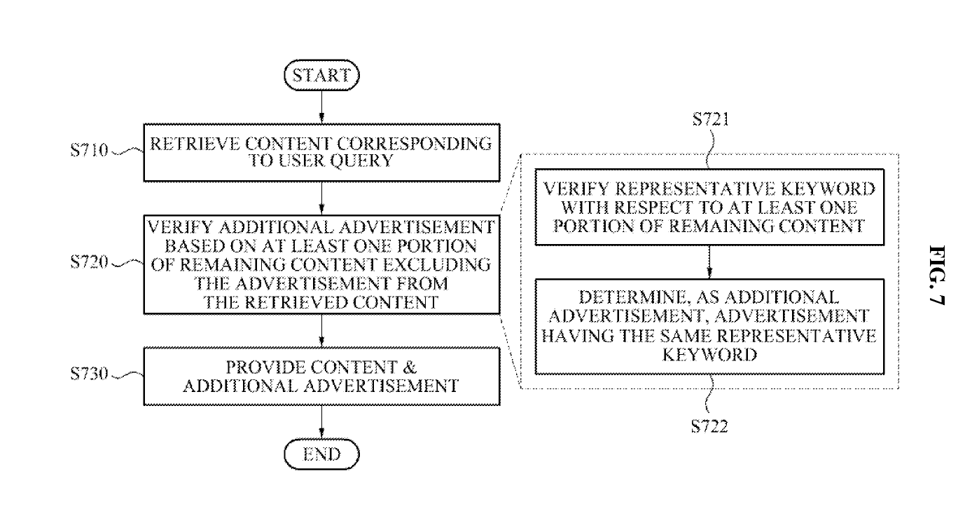

FIG. 7 is a flowchart illustrating a method of providing an advertisement according to another exemplary embodiment of the present invention. The advertisement providing method may be performed by an advertisement providing system according to another exemplary embodiment of the present invention. In FIG. 7, the advertisement providing method will be described by describing each operation performed by the advertisement providing system.

In operation S710, the advertisement providing system may retrieve a content corresponding to a user query. The advertisement providing system may retrieve the content corresponding to the user query by employing a search engine and the like with respect to the user query input from a user.

In operation S720, the advertisement providing system may verify an additional advertisement based on at least one portion of a remaining content excluding an advertisement from the content. The advertisement providing system may verify the additional advertisement using a similarity between contents based on a vocabulary included in at least one portion of the remaining content. For the above operation, as shown in FIG. 7, the advertisement providing system may perform operations S721 and S722 included in operation S720.

In operation S721, the advertisement providing system may verify a representative keyword with respect to at least one portion of the remaining content. For example, the remaining content may indicate a general text excluding the advertisement. In this case, the advertisement providing system may verify the representative keyword with respect to each general text of the remaining content. In this instance, the representative keyword may be determined based on the user query used for exposing of the general text and a click log, or may be determined based on a vocabulary included in at least one portion of the general text.

In operation S722, the advertisement providing system may determine, as the additional advertisement, an advertisement having the same representative keyword as the verified representative keyword. That is, a representative keyword may be determined with respect to each of advertisements. The advertisement providing system may determine, as the additional advertisement, another advertisement having, as the representative keyword, the same keyword as the representative keyword determined with respect to the remaining content. Here, a number of additional advertisements may be adjusted based on a preset value or a predetermined value.

In operation S730, the advertisement providing system may provide the content and the additional advertisement. The user query may be received using a user terminal of the user. The advertisement providing system may provide the content and the additional content by transmitting URL information of a page including the content and the additional advertisement or URL information of each of a page including the content and a page including the additional advertisement.

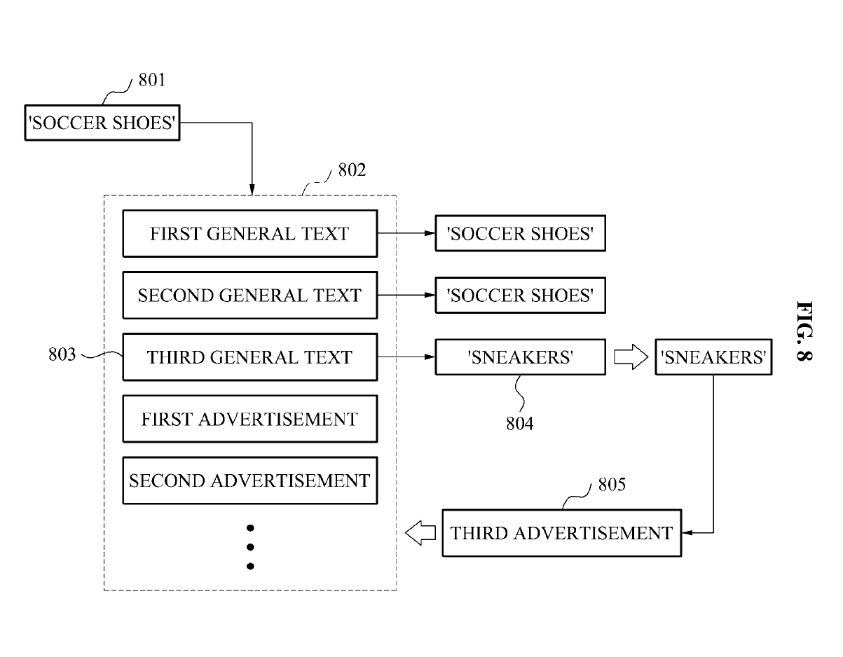

FIG. 8 is a diagram illustrating an example of providing an advertisement according to another exemplary embodiment of the present invention. When a user query ‘soccer shoes’ 801 is input and a search result 802 including a plurality of general texts and advertisements is verified, an advertisement providing system according to another exemplary embodiment of the present invention may verify a representative keyword with respect to only a remaining content excluding the plurality of advertisements, i.e., with respect to only at least one general text. In this instance, general texts having the same representative keyword as the user query ‘soccer shoes’ 801 may be included in the remaining content, or may be excluded from the remaining content. In the example of FIG. 8, the advertisement providing method will be described with the assumption that general texts having the same representative keyword ‘soccer shoes’ 801 are excluded from the remaining content. Specifically, by including, in the search result 802, a third advertisement 805 having the same representative keyword as the remaining content having the representative keyword ‘soccer shoes’ 804 like a third general text 803, and by providing the user with the search result, it is possible to increase a number of exposures of the advertisement.

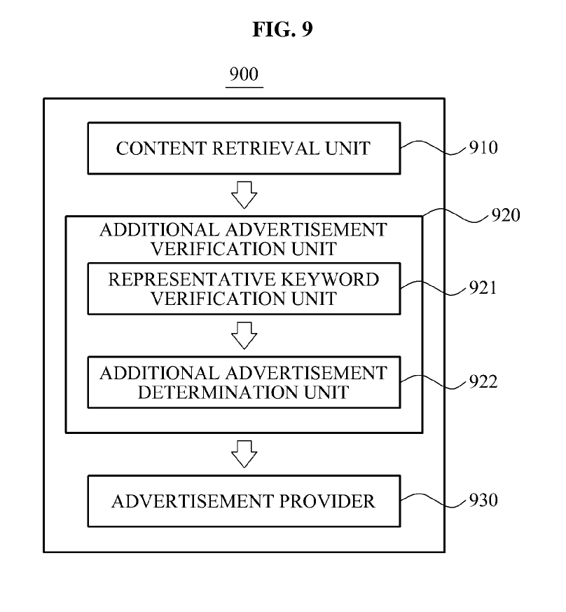

FIG. 9 is a block diagram illustrating a configuration of an advertisement providing system 900 according to another exemplary embodiment of the present invention. Referring to FIG. 9, the advertisement providing system 900 may include a content retrieval unit 910, an additional advertisement verification unit 920, and an advertisement provider 930.

The content retrieval unit 910 may retrieve a content corresponding to a user query. In this instance, the content retrieval unit 910 may retrieve the content corresponding to the user query by employing a search engine and the like with respect to the user query input from a user.

The additional advertisement verification unit 920 may verify an additional advertisement based on at least one portion of a remaining content excluding an advertisement from the content. The additional advertisement verification unit 920 may verify the additional advertisement using a similarity between contents based on a vocabulary included in at least one portion of the remaining content. For the above operation, as shown in FIG. 9, the additional advertisement verification unit 920 may include a representative keyword verification unit 921 and an additional advertisement determination unit 922.

The representative keyword verification unit 921 may verify a representative keyword with respect to at least one portion of the remaining content. For example, the remaining content may indicate a general text excluding the advertisement. In this case, the representative keyword verification unit 921 may verify the representative keyword with respect to each general text of the remaining content. Here, the representative keyword may be determined based on the user query used for exposing of the general text and a click log, or may be determined based on a vocabulary included in at least one portion of the general text.

The additional advertisement determination unit 922 may determine, as the additional text, an advertisement having the same representative keyword as the verified representative keyword. That is, a representative keyword may be determined with respect to each of advertisements. The additional advertisement determination unit 922 may determine, as the additional advertisement, another advertisement having, as the representative keyword, the same keyword as the representative keyword determined with respect to the remaining content. Here, a number of additional advertisements may be adjusted based on a preset value or a predetermined value.

The advertisement provider 930 may provide the content and the additional advertisement. The user query may be received using a user terminal of the user. The advertisement provider 930 may provide the content and the additional advertisement by transmitting, to the user terminal, URL information of a page including the content and the additional advertisement or URL information of each of a page including the content and a page including the additional advertisement.

An advertisement providing system or an advertisement providing method according to another exemplary embodiment of the present invention may effectively provide a user with an additional advertisement and enhance the advertisement effect and sales by providing the additional advertisement using a remaining content excluding an advertisement from a content retrieved in response to a user query input from the user.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A system for providing a search result, comprising:
a content retrieval unit to retrieve a content corresponding to a user query;
a similar content verification unit to verify a similar content based on at least one portion of the retrieved content; and
a content provider to provide the similar content in response to the user query.

2. The system of claim 1, wherein the similar content verifying unit verifies the similar content using a similarity between contents based on a vocabulary corresponding to at least one portion of the retrieved content.

3. The system of claim 1, wherein the similar content verification unit comprises:
a representative keyword verification unit to verify a representative keyword with respect to at least one portion of the retrieved content; and
a similar content determination unit to determine, as the similar content, a content having the same representative keyword as the verified representative keyword.

4. The system of claim 3, wherein the representative keyword is determined based on a click log.

5. The system of claim 1, wherein:
the user query is received using a user terminal, and
the content provider transmits, to the user terminal, uniform resource locator (URL) information of a page including the retrieved content and the similar content or URL information of each of a page including the retrieved content and a page including the similar content.

6. A system for providing an advertisement, comprising:
an advertisement retrieval unit to retrieve an advertisement of an advertiser associated with a keyword corresponding to a user query;
a similar advertisement verification unit to verify a similar advertisement based on at least one portion of the advertisement of the advertiser; and
an advertisement provider to provide the similar advertisement in response to the user query.

7. The system of claim 6, wherein the similar advertisement verification unit verifies the similar advertisement using a similarity between contents based on a vocabulary included in at least one portion of the advertisement of the advertiser.

8. The system of claim 6, wherein the similar advertisement verification unit comprises:
a representative keyword verification unit to verify a representative keyword with respect to at least one portion of the advertisement of the advertiser; and
a similar advertisement determination unit to determine, as the similar advertisement, an advertisement having the same representative keyword as the verified representative keyword.

9. A system for providing an advertisement, comprising:
a content retrieval unit to retrieve a content corresponding to a user query;
an additional advertisement verification unit to verify an additional advertisement based on at least one portion of a remaining content excluding a first advertisement from the retrieved content; and
an advertisement provider to provide the content and the additional advertisement.

10. The system of claim 9, wherein the additional advertisement verification unit verifies the additional advertisement using a similarity between contents based on a vocabulary included in at least one portion of the remaining content.

11. The system of claim 9, wherein the additional advertisement verification unit comprises:
a representative keyword verification unit to verify a representative keyword with respect to at least one portion of the remaining content; and
an additional advertisement determination unit to determine, as the additional advertisement, an advertisement having the same representative keyword as the verified representative keyword.

12. The system of claim 8 or 11, wherein the representative keyword is determined based on a click log.

13. A method of providing a search result, comprising:
retrieving a content corresponding to a user query;
verifying a similar content based on at least one portion of the retrieved content; and
providing the similar content in response to the user query.

14. The method of claim 13, wherein the verifying comprises verifying the similar content using a similarity between contents based on a vocabulary corresponding to at least one portion of the retrieved content.

15. The method of claim 13, wherein the verifying comprises:
verifying a representative keyword with respect to at least one portion of the retrieved content; and
determining, as the similar content, a content having the same representative keyword as the verified representative keyword.

16. A method of providing an advertisement, comprising:
retrieving an advertisement of an advertiser associated with a keyword corresponding to a user query;
verifying a similar advertisement based on at least one portion of the advertisement of the advertiser; and
providing the similar advertisement in response to the user query.

17. The method of claim 16, wherein the verifying the similar advertisement comprises verifying the similar advertisement using a similarity between contents based on a vocabulary included in at least one portion of the advertisement of the advertiser.

18. The method of claim 16, wherein the verifying of the similar advertisement comprises:
verifying a representative keyword with respect to at least one portion of the advertisement of the advertiser; and
determining, as the similar advertisement, an advertisement having the same representative keyword as the verified representative keyword.

19. A method of providing an advertisement, comprising:
retrieving a content corresponding to a user query;
verifying an additional advertisement based on at least one portion of a remaining content excluding a first advertisement from the retrieved content; and
providing the content and the additional advertisement.

20. The method of claim 19, wherein the verifying comprises verifying the additional advertisement using a similarity between contents based on a vocabulary included in at least one portion of the remaining content.

21. The method of claim 19, wherein the verifying comprises:
verifying a representative keyword with respect to at least one portion of the remaining content; and
determining, as the additional advertisement, an advertisement having the same representative keyword as the verified representative keyword.

22. (canceled)

23. The system of claim 16, wherein the advertisement of the advertiser is purchased by the advertiser, and the similar advertisement comprises at least one of other advertisements of the advertiser and advertisements of other advertisers who have not purchased the keyword.

24. The method of claim 6, wherein the advertisement of the advertiser is purchased by the advertiser, and the similar advertisement comprises at least one of other advertisements of the advertiser and advertisements of other advertisers who have not purchased the keyword.
